(19) United States
(12) Patent Application Publication
(10) Pub. No.: US 2008/0232584 A1
(43) Pub. Date: Sep. 25, 2008

(54) HAND-HELD DECODER CARD HAVING A PARALLAX BARRIER PORTION AND A LIGHT FILTERING PORTION AND METHOD OF MAKING SAME

(75) Inventors: Pierre Gougeon, Rosemere (CA); Louis Sebastien Rouleau, Blainville (CA)

Correspondence Address: BENOIT & CO., 2025 Limoges Street, LONGUEUIL - QUEBEC, J4G 1C4, CA

(73) Assignee: Photogram Technologies Inc., Lachenaie (CA)

(21) Appl. No.: 12/052,236

(22) Filed: Mar. 20, 2008

Related U.S. Application Data
(60) Provisional application No. 60/896,316, filed on Mar. 22, 2007.

(51) Int. Cl. G09C 5/00

(52) U.S. Cl. 380/54

(57) ABSTRACT

The present document describes a hand-held decoder card for revealing information hidden in a printed material and information hidden in a color image and method of making the same. The hand-held decoder card comprises: translucent material having a parallax barrier portion comprising parallel barrier lines for revealing the information hidden in the printed material; and the translucent material having a light filtering portion comprising a light filter for revealing the information hidden in the color image. According to various embodiments, the hand-held decoder card is in a transactional card format. The card may include only the parallax barrier portion or the light filtering portion. Also, the hand-held card may be a monocoque card or a laminated card.

### CROSS-REFERENCE TO RELATED APPLICATIONS

This application claims priority under 35USC§119(e) of U.S. provisional patent applications 60/896,316, filed Mar. 22, 2007 and entitled “LOYALTY PROGRAM USING DECODING CARD”, the specification of which is hereby incorporated by reference.

### TECHNICAL FIELD

This description relates to the field of hand-held loyalty card and the methods of making the same. More particularly, this description relates to hand-held cards having a decoder portion.

### BACKGROUND OF THE INVENTION

In the promotional, gaming and loyalty industries, it is known to be useful to have tools that are able to “reveal” concealed information in different types of media (printed or electronic), or act as a viewing tool for stereoscopic images. Such tools can be used to introduce games, contests or sweepstakes to specific audiences.

Typically, existing tools are tedious to manufacture when one wishes to combine different viewing and encoding/decoding techniques in the same piece. Furthermore, promoters are always looking for new ways to attract and retain clients.

### SUMMARY OF THE INVENTION

According to an aspect of the invention, there is provided a hand-held decoder card for revealing information hidden in a printed material and information hidden in a color image. The hand-held decoder card comprises: translucent material having a parallax barrier portion comprising parallel barrier lines for revealing the information hidden in the printed material; and the translucent material having a light filtering portion comprising a light filter for revealing the information hidden in the color image.

According to another aspect of the invention, there is provided a hand-held decoder card for revealing information hidden in a printed material and information hidden in a color image. The hand-held decoder card comprises: translucent material having a transactional card format; and the translucent material having a light filtering portion comprising a light filter for revealing the information hidden in the color image, the light filter having a specified color, the color being selected from one of the pantone colors.

According to another aspect of the invention, there is provided a hand-held decoder card for revealing information hidden in a printed material and information hidden in a color image. The hand-held decoder card comprises: translucent material having a transactional card format; and the translucent material having a parallax barrier portion comprising parallel barrier lines for revealing the information hidden in the printed material.

According to another aspect of the invention, there is provided a method of using a plurality of cards described above, wherein the parallax barriers of at least some cards have a different specified distance between them, the different cards hence revealing different information in the printed material and thereby providing a security measure.

According to another aspect of the invention, there is provided a method for making a hand-held decoder card comprising a parallax barrier portion and a light filtering portion. The method comprises: providing a translucent material; impressing a parallax barrier portion comprising parallel barrier lines on a corresponding part of the translucent substrate material; and impressing a light filtering portion comprising a light filter on another corresponding part of the translucent substrate material to provide the hand-held decoder card.

According to another aspect of the invention, there is provided a method for making a hand-held decoder card comprising a parallax barrier portion and a light filtering portion. The method comprises: providing a translucent material in transactional card format; and impressing a parallax barrier portion comprising parallel barrier lines on a corresponding part of the translucent substrate material.

According to another aspect of the invention, there is provided a method for making a hand-held decoder card comprising a parallax barrier portion and a light filtering portion. The method comprises: providing a translucent material in transactional card format; and impressing a light filtering portion comprising a light filter on another corresponding part of the translucent substrate material to provide the hand-held decoder card.

### BRIEF DESCRIPTION OF THE DRAWINGS

Further features and advantages of the present invention will become apparent from the following detailed description, taken in combination with the appended drawings, in which:

FIG. 1 is a block diagram illustrating the steps of setting up a loyalty program using decoding cards, in accordance with embodiments of the present invention.

FIG. 2a is a diagram showing a hand-held decoder card having a parallax barrier portion and a light filtering portion;

FIG. 2b is a diagram showing a hand-held decoder card having a parallax, a light filtering portion and an information bearing portion;

FIG. 2c is a diagram showing a side elevation view of hand-held decoder card having a barrier layer and a light filtering layer;

FIG. 2d is a diagram showing a side elevation view of hand-held decoder card having a barrier layer, a light filtering layer, an information bearing layer and a liner layer;

FIG. 2e is a diagram showing a hand-held decoder card wherein the parallax barrier portion 210 comprises two parts each having a different specified distance between the parallel barrier lines;

FIG. 2f is a diagram showing a hand-held decoder card in a transactional card format and having a parallax barrier portion;

FIG. 2g is a diagram showing a hand-held decoder card in a transactional card format and having a light filtering portion;

FIG. 2h is a diagram showing a hand-held decoder card wherein the light filtering portion 210 comprises two parts each having a different of different colors; and

FIG. 3 is a flowchart showing how the hand-held decoder card is manufactured according to an embodiment.

It will be noted that throughout the appended drawings, like features are identified by like reference numerals.

### DETAILED DESCRIPTION

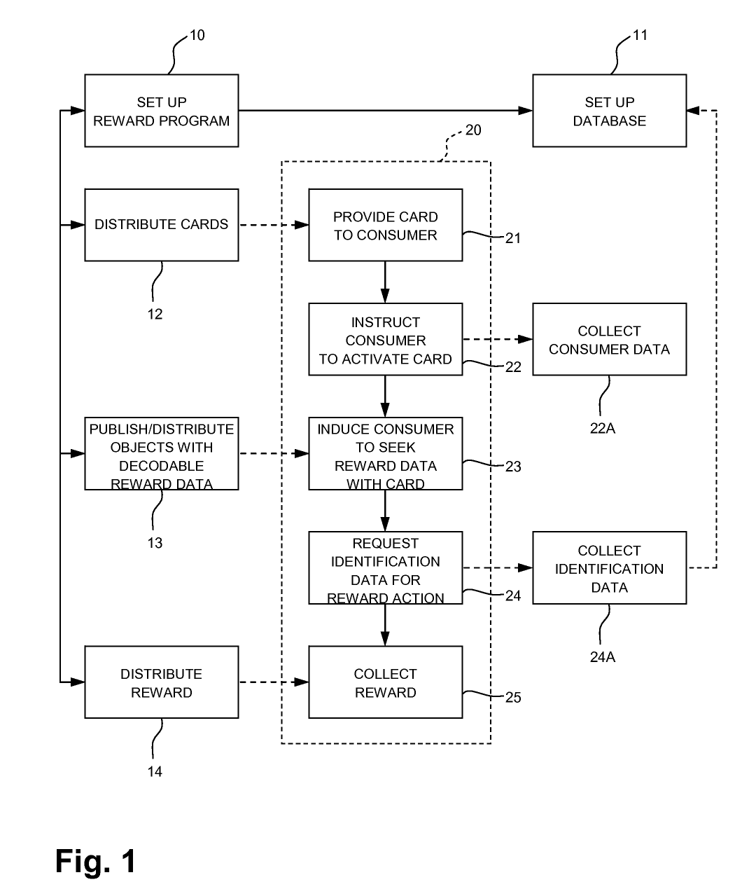

Referring now to the drawings, and more particularly to FIG. 1, a block diagram illustrates the steps of setting up a loyalty program along with its implementation with consumers.

The set up of the loyalty program is generally illustrated as step 10. The set-up step 10 involves setting up the loyalty program for the purposes of (1) gathering information about a consumer base, (2) inducing the purchase of products by the consumers, and/or (3) increasing advertisement/coop revenue. The loyalty program is typically used by entities using large amounts of printed publications, such as supermarkets and other food stores, clothing retailers and stores (including shoe and sport stores), drugstores, jewelry stores.

These purposes are achieved by way of a method/process in which consumers will decode information in media of different types, to subsequently log in a database with the information to run the chance of being rewarded, while the relationship progresses between the retailer and the consumer.

The various sub-steps performed to implement the loyalty program so as to maximize the convergence effect of the decoding card are directly related to the set-up step 10. Accordingly, the set-up 10 and related sub-steps will be described together.

In step 11, a database is set up. The database will be accessible by consumers which will enter information therein. Contemplated interfaces between the consumers and the database are mainly paper publications, as well as the internet and telephone systems.

In step 12, decoding cards are distributed, sold, or rendered available to consumers. The card may take different forms, but is preferably of the CR-80 wallet format, with a decoding tool on the card. The decoding tool is a lenticular, line-barrier decoder, and/or color decoder. Various configurations of the card will be described hereinafter.

It is considered to give courtesy decoding cards to preferred consumers, to sell cards to other consumers. More specifically, it is suggested to have different categories of decoding card available as a function of the loyalty program. Different categories of cards include promotional cards, for instant rewarding, or clue-gathering rewarding. The distributed cards may be relationship cards as well, so as to gather consumer profile data. The cards may also be loyalty, inducing the consumer to be loyal, transactional (credit, debit, gift cards), or a combination of such categories (e.g., transactional and loyalty, promotional and transactional). The distribution of cards according to step 12 may be a mass distribution, with the distribution of a large volume of cards without specific consumer request, or a distribution on consumer demand: distribute cards only to consumer requesting the decoding card.

In step 13, objects are distributed, published or printed with decodable reward data. These objects must be circulated to be available to the consumers, whether it be in the form of printed advertising (weekly flyer or the like), newspapers, magazines, cash register receipts or like point-of-sale material, client account statements, product packaging, coupons, cards inside products (e.g., coupons inside bags of edible items such as bags of chips).

The objects are not limited to paper publications, as it is considered to provide the decodable reward data on many types of display devices and consumer interfaces, such as computer screens in the form of websites/internet and/or e-mails, SMS, podcasts (for media players such as the iPod™), cellular phones, PDA devices, large screen projection (movie theater), television, cash register monitor screen, monitors installed on retailer shopping carts, on-board vehicle monitor systems, as well as ATM machines

In many instances, the publication of decodable data allows to increase marketing revenues by the publisher or diffuser of the object, as the presence of decodable reward data will cause an increase of penetration rate for the publications as well as for the converging media related to the campaign of loyalty program. For instance, it is suggested that advertising space will be sold for greater revenue to suppliers as a result of the value-added decoding process in the various types of media described above.

Moreover, step 13 includes the distribution of objects with the decodable reward data by sale. For instance, the decodable reward data may be provided by the purchase of a specific product at a retail outlet, thereby increase the number of visits at the point of sale. In these instances, decodable reward data may be spread out throughout the premises. Moreover, cross promotion activity linked to the use of decoding card can be used when selling the objects. Cross-promotion refers to an activity jointly organized with the entity setting up the loyalty program and one of its suppliers, in which the supplier pays to associate its products with the decodable reward data.

As part of the loyalty program, the decodable reward data may be used to increase converging media activity. This will be described in further detail hereinafter.

In step 14, rewards are distributed to the consumers who have obtained the necessary information through the decoding of data. The rewards are in various forms, such as discounts, instant prize (smaller products) and like rewards available at retail location. Rewards of higher value may be sought after by entering into a contest (collating more data with the decoding card by the consumer) to win a larger prize.

To obtain the necessary information to collect the reward, the consumer is induced in performing a plurality of steps set forth by method 20.

In step 21, the decoding card is provided to the consumer, according to the distribution scheme set forth for step 12 described above.

In step 22, the consumer is instructed to activate the card. The consumer will have to log in some way to the database of the loyalty program, such that a consumer profile is established. The activation involves associating the consumer profile (name, age, address, consumption habits) with a specific card (e.g., PIN, barcode, magnetic stripe, chip, or the like). The consumer profile data is preferably required for the card to be activated and for the consumer to be registered to participate in the loyalty program. An access code may be given to the consumer upon registration to ensure that all participants in the loyalty program are validly registered.

Contemplated ways by which the consumer may populate the database are by telephone, by internet, and/or by filling paper publications (e.g., form). Moreover, the retailer may perform the steps of registration for the consumer in the presence of the consumer.

As shown by step 22A, consumer data is collected in the database.

In step 23, the consumer is encouraged to seek reward data by using the decoding card to decode the data.

In step 24, actions are required by the consumer to progress in the quest for the reward. To perform these types of actions, the consumer is asked to provide identification data. The consumer may therefore be exposed to an advertising campaign in the plurality of media described above. The consumer is instructed to take action by being encouraged to play the game of decoding reward data with the decoding card. The request for identification data in step 24 is intended to direct the consumer to another type of media, such as paper publication, website or a phone line, in which the identification of the consumer will be entered.

The search for clues revealed by the decoding card may lead the consumer from medium to medium, in circular fashion (from medium X to medium Y to medium Z and back to medium X and so on). Regardless of the entry point, combinations that are considered are: from paper advertising to web, to point-of-sale, to television or to any other type of display/media advertising, from television advertising to paper, to web, to point-of-sale or to any other type of display/media advertising, from point-of-sale advertising to any other type of display/media advertising, to paper, to web, to television, from web advertising to paper, to point-of-sale, to television, from any other type of display/media advertising to paper, to web, to television, to point-of-sale.

In the process, expose consumer multiple times to the advertising-marketing-communication converging message. As a result, the cumulative effect of a larger number of consumer exposures provides a convergent and synergic effect as an added value to the activity, compared to a one-time-only exposure.

As shown by step 24A, consumer data is collected in the database. If demographic information has been collected regarding the consumer via steps 22A and 24A, it is contemplated that adapted messages can be presented to consumer, linked to the collected demographic information.

The information collected by the database is advantageously used as it pertains to consumer profiles, whereby behavioral information can be derived for subsequently cross-selling or up-selling products, or for database cross referencing. With the reward data provided by the consumer in the reward actions and the various logins of the consumer to the database of the loyalty program, it is possible to trace the sequence of actions of the consumer.

Once the consumer has performed all required loyalty actions, the consumer gets to collect the reward. The consumer may be directed to the retailer to collect the reward.

Referring to FIG. 1, the database is described as being operated by the entity setting up the loyalty program. It is also considered to have independent web servers providing data decodable with the decoding card. In such a case, it is suggested to operate another parallel loyalty/reward/entertainment program not associated with the one described for FIG. 1.

The independent web server proposes all appealing aspects of the loyalty program, such as a clue-type game with decodable information (e.g., uploaded images, videos (3D), anaglyph) to lead to reward prizes, items for sale at discount prizes through the decoding of information. Accordingly, revenues can be generated by the entities running the independent web servers in the form of advertising revenue (e.g., promotional banners). Moreover, entities running the loyalty programs such as the one described in FIG. 1 may also advertise their loyalty programs on the independent web servers.

It is suggested to have the independent web servers gather identification data pertaining to the consumers. Collected identification data is then used to establish behavioral patterns and consumer profiles to improve the performance of the loyalty/reward/entertainment programs and the hits on the independent web servers.

The decoding card is typically a CR-80 wallet-size card that is readily carried around by the consumer. The decoding card may take various formats, such as a lenticular animated card, a card with lenticular decoder (i.e., decrypter), an RFID card (radio-frequency identification), a card with a barrier-line filter, and/or a card with a color filter with or without a lens portion. The card is optionally an information bearing card with a PIN number, a barcode or magnetic stripe, a chip, and other technologies such as information displaying technologies. The card may have various construction features as well to interest several members of the same family who will own their personalized decoding card with their own identification profiles allowing each family member to participate in contest segments in relation to their age/gender group.

In the embodiment in which the decoding card has a color filter, the color filter may be a single-color decoder, or a combination of colors decoder (e.g., two colors 3D glasses style (red/green, red/blue) used to view anaglyphic images). The decoding card may bear a polarizer-film filter, in combination with combined color/lenticular/polarizer film filters. Alternatively, regular plastic cards (non-lenticular) may be used as well.

Although the CR-80 format is preferred as it is readily carried around by the consumer with other cards of the same size (credit cards, debit cards) and therefore facilitates point-of-sale reward actions, the transactional decoding card has in one embodiment a hand-held decoder format to be used in other circumstances.

When the decoding card has a color filter, it is considered to use a specific set of colors. For instance, Pantone® colors are particularly well suited to be used for the color filter. Pantone® colors are described at http://fr.wikipedia.org/wiki/Pantone_Inc. and in <<Pantone® formula guide, First Edition 2002, Fourth Printing>>. Amongst the pantone colors are: <<solid coated>> orange codes 150 to 173, including subcode 1505, red codes 178 to 222, and 485, red 032 C, rub. red C, warm red C, magenta codes 225 to 249, rhodamine red C, process magenta, purple codes 252 to 272, and 484 to 527, purple C, 1545-C, blue codes 2726 to 3035 (i.e., 272 to 303), 534 to 548, 7455 to 7459, 7462, 7463, 7473 to 7477, blue 072 C, process blue C, cyan codes 306 to 323, 7460 to 7463, 7466 to 7470, hexachrome cyan C, process cyan C, green codes 326 to 378, 554 to 576, 7480 to 7484, 803, 808, hexachrome green C, green C.

Barrier-line filters are advantageously used over lenticular filters/lens for the decoding card as the barrier-line filters can be manufacture according to simpler processes, as opposed to the lenticular cards which are typically extruded or moulded. The barrier-line filter portions can be printed onto transparent cards, and may be used to decrypt lenticular-type encryption if provided with the suitable specifications.

As another alternative, decryptable reward data may be in the form of light-illuminated data. In such as case, the reward data is revealed by being illuminated with light of a specific color. The card itself may then comprise the reward data, which can be decoded by a light source of a specific corresponding color.

Now that the set up of the decoding card a loyalty program and the embodiments of the decoding card have been described, an example of a reward program is described.

In the example, the reward data takes the form of clues which, upon being solved, result in a reward of greater value being awarded to the consumer. Moreover, the reward data includes codes that are used by the consumer at the purchase of products to instantaneously obtain discounts on the product being purchased or other products at the point of sale, or prizes of lesser value.

The entity setting up the program is a retailer distributing cards according to steps 12/21 to clients spending more than an amount X at the retailer's outlet. Moreover, the decoding cards can be sold to consumers.

According to step 22, the consumer must activate the card by providing personal information such as name, age, address, and/or email address or simply a user code that has been obtained with the decoding card, which user code is specific to the card.

According to step 13, the retailer circulates decodable reward data in different formats, such as printed advertisement, ads in local papers, amongst the numerous examples described above. The consumer will be able to decode the reward data with his/her decoding card.

In step 24, the consumer is instructed to login to the database of the retailer to perform reward actions. In the present example, the reward data is a code (obtained by using the decoding card to decode reward data on paper flyers) that must be entered on a website of the retailer to get a clue for the larger reward, or to get instant gratification in the form of a discount on an item, a free trip, a gift, goods, the access to a game (e.g., video game, trivia question-and-answer game, edutainment game), etc. The consumer must however enter personal identification data in relation to the card identification to perform the reward action.

In the quest for the reward of larger value, the consumer must repeatedly login to the website and or interact with multiple converging media to get more clues. Once the consumer has a correct response following the clues, the reward is collected as shown at step 25.

With the correct response, the consumer collects the reward according to step 25 at the retailer's outlet, any participating entities or any suitable premises in regard to the nature of the reward.

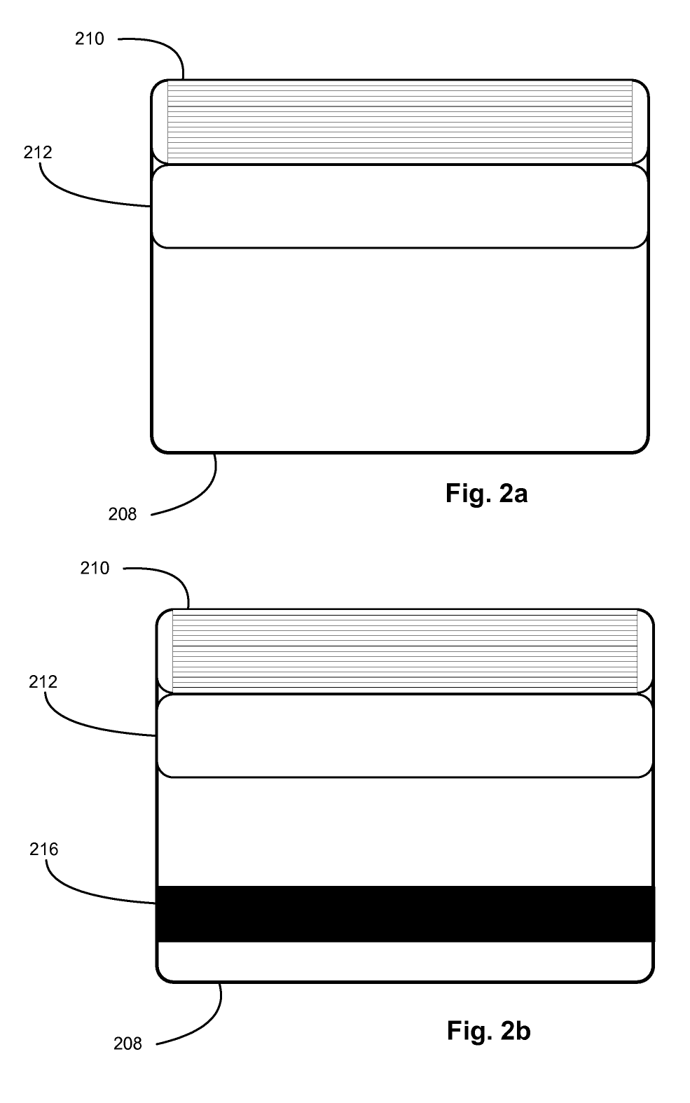

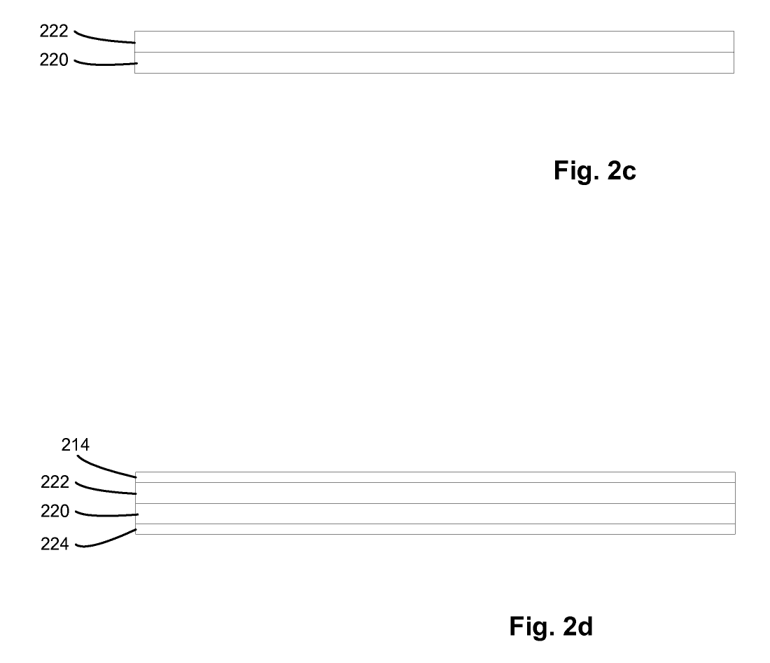

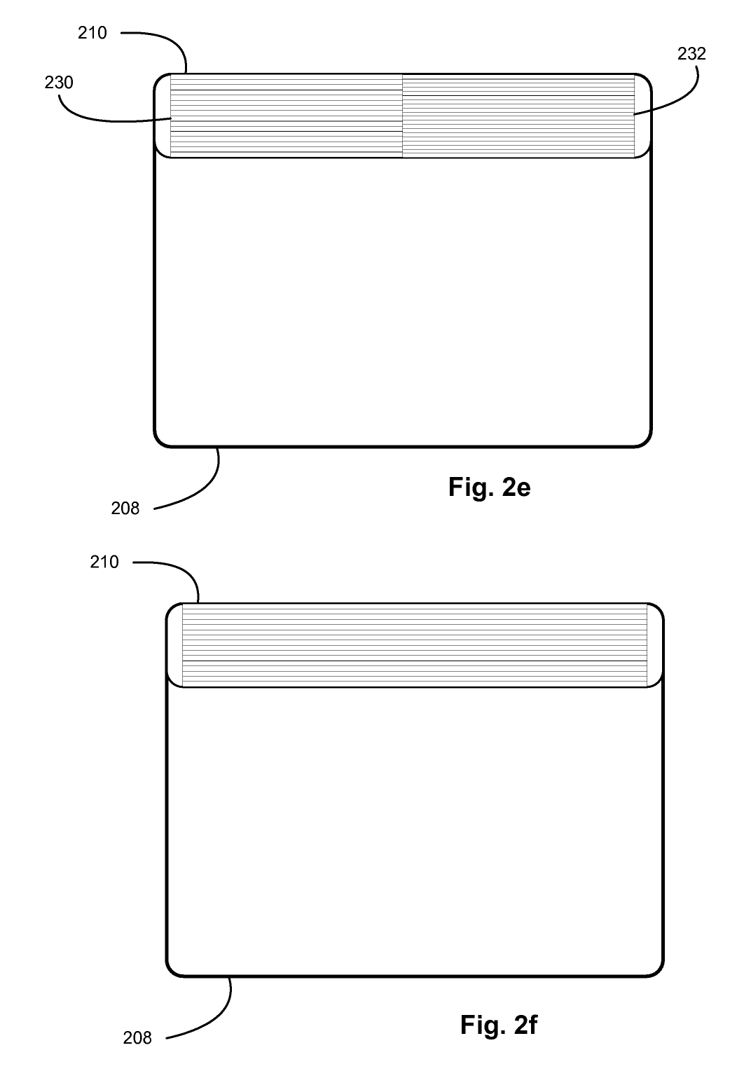

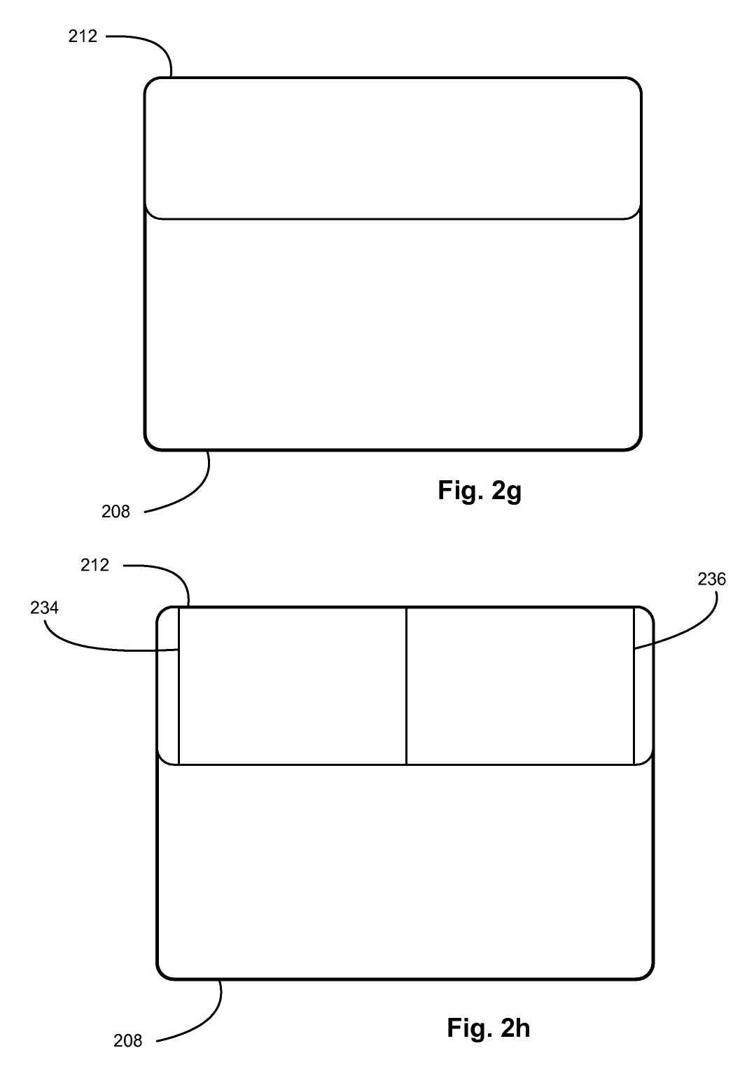

Now referring to FIG. 2a, there is shown an embodiment of a hand-held decoder card 208.

In one embodiment, the hand-held decoder card 208 is a wallet-size card (e.g., CR 80 format). It will be appreciated that the hand-held decoder card 208 may be of various sizes and shapes depending on the particular application and standard in each country. Therefore, the hand-held decoder card may by of any format which is useful for transactional cards. It will be further appreciated that the hand-held decoder card 208 may have a thickness comprised between 4 mil (0.004 inch) and 60 mil (0.06 inch). It will be appreciated that in one embodiment, the hand-held decoder card 208 is built in layers.

The hand-held decoder card 208 comprises a parallax barrier portion 210 and a light filtering portion 212.

In an embodiment, the parallax barrier portion 210 is an upper horizontal parallax barrier portion while the light filtering portion 212 is a lower horizontal light filtering portion.

The parallax barrier portion 210 is capable of revealing information hidden (encoded) in a printed material using well-known image interlacing techniques_while the light filtering portion 12 is capable of revealing information hidden in a color image through appropriate filtering, using well-known color filtering techniques.

The parallax barrier portion 210 is a transparent screen window used to decode indicia in a printed substrate. In fact, the light filtering portion 212 comprises a transparent plastic screen window used to decode indicia encoded with color filtering techniques on a printed substrate and/or TV screen or monitor.

According to another embodiment, the hand-held decoder card comprises a single layer of translucent material, thereby defining a monocoque card and the parallax barrier portion 210 and the light filtering portion 212 are on the single layer.

Referring to FIG. 2b, there is shown an embodiment of the hand-held decoder card 208 wherein the translucent material further comprises an information bearing layer comprising an information bearing portion 216. The information bearing portion 216 comprises at least one of: a magnetic stripe, barcode, RFID, chip and PIN number.

Referring to FIG. 2c, there is shown a left side elevation view of the hand-held decoder card 208 according to an embodiment. The hand-held decoder card 208 comprises the parallax barrier portion 210 on a barrier layer 220 and the light filtering portion 212 on a filter layer 222.

Now referring to FIG. 2d, there is shown a left side elevation view of the hand-held decoder card 208 according to an embodiment wherein the translucent material further comprises a liner layer 224 on which are applied the barrier layer 220, the filter layer 222 and the information bearing layer 214.

According to an embodiment, the liner layer 224 has a thickness which is substantially equal to 2 thousands of an inch, the barrier layer 220 has a thickness which is substantially equal to 12 thousands of an inch, the filter layer 222 has a thickness which is substantially equal to 12 thousands of an inch, and the information bearing layer 214 has a thickness which is substantially equal to 2 thousands of an inch. The resulting hand-held decoder card has a thickness substantially equal to 28 thousands of an inch.

Now referring to FIG. 2e, there is shown an embodiment of the hand-held decoder card 208 wherein the parallax barrier portion 210 comprises two parts 230 and 232 each having a different specified distance between the parallel barrier lines thereby permitting viewing of different information hidden in the printed material.

Now referring to FIG. 2f, there is shown an embodiment of the hand-held decoder card 208 wherein the translucent material is provided in a transactional card format and wherein the translucent material has a parallax barrier portion 210 comprising parallel barrier lines for revealing the information hidden in the printed material.

Now referring to FIG. 2g, there is shown an embodiment of the hand-held decoder card 208 wherein the translucent material is provided in a transactional card format and wherein the translucent material has a light filtering portion 212 comprising a light filter for revealing the information hidden in the color image, the light filter having a specified color, the color being selected from one of the Pantone® colors (see <<Pantone® formula guide, First Edition 2002, Fourth Printing>>).

Referring to FIG. 2h, there is shown an embodiment of the hand-held decoder card 208 wherein the light filtering portion 212 comprises two parts 234 and 236 of different colors thereby permitting viewing of two different images. One part for each eye of a viewer, resulting in a three-dimensional effect (anaglyph style). The two parts can also be used for revealing different information as well.

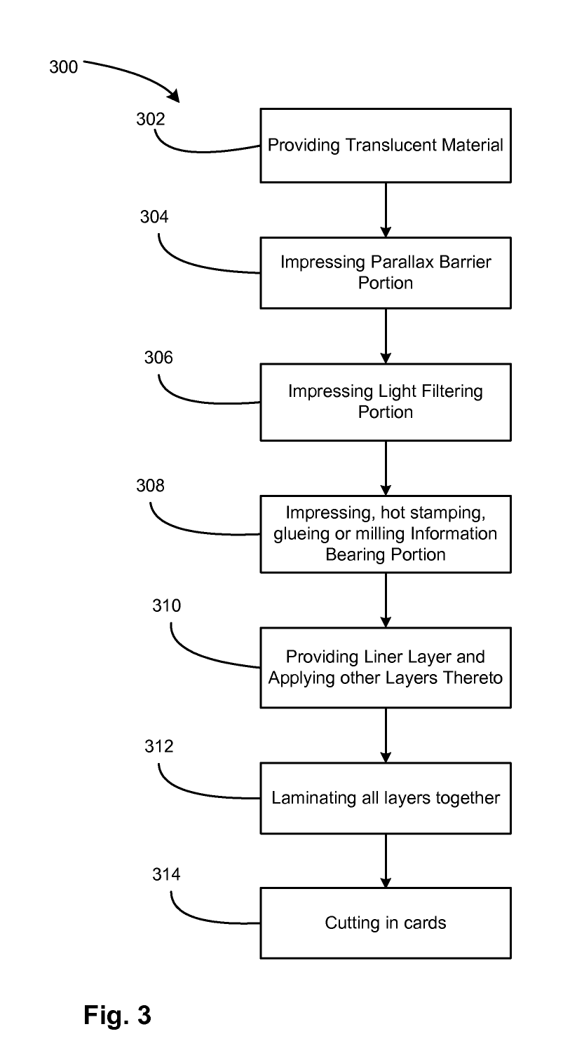

Now referring to FIG. 3, there is shown a method 300 of making the hand-held decoder card 208 according to an embodiment.

According to step 302, a translucent material is provided. In one embodiment, the translucent substrate material is provided in sheets.

In an embodiment, the translucent substrate material is Polyethylene Terepthalate Glycol (PETG). Alternatively, the translucent substrate material may be one of APET and plastic acrylic, PET, PP, PS or any other type of plastic used to create transactional plastic cards. The skilled addressee should appreciate that other suitable materials may be used.

According to step 304, a parallax barrier portion 10 is impressed on a corresponding part of the translucent material. The parallax barrier portion 210 is impressed using a suitable impressing means. The impressing means includes but is not limited to one of flexography, lithography, serigraphy, screen print, silkscreen printers, inkjet or laser. According to an embodiment, the portion on which the parallax barrier portion 210 is impressed is a layer of translucent material referred to herein as a barrier layer.

According to step 306, a light filtering portion 212 of the hand-held decoder card 208 is impressed on another corresponding part of the translucent material. The light filtering portion 212 is created using the suitable impressing means (flexography, lithography, serigraphy, screen print, silkscreen printers, INKJET or LASER). According to an embodiment, the portion on which the light filtering portion 212 is impressed is a layer of translucent material referred to herein as a filter layer. Alternatively, the light filtering portion 212 may be pre-manufactured (e.g., in a thin sheet of a translucent color substrate) and laminated to another card layer.

While it has been disclosed that the parallax barrier portion 210 is impressed on a corresponding part of the substrate material first. It should be understood by the skilled addressee that the light filtering portion 212 may be impressed first. Alternatively, the parallax barrier portion 210 and the light filtering portion 212 may be concurrently impressed on the substrate material.

According to step 308, an information bearing portion 220 of the hand-held decoder card 208 is impressed on another corresponding part of the translucent material. According to an embodiment, the portion on which the information bearing portion 220 is impressed, laminated, glued or milled is a layer of translucent material referred to herein as an information bearing layer.

According to step 310, a liner layer is provided and the barrier layer, the filtering layer and the information bearing layer are applied to the liner layer.

According to step 312, all layers are laminated together in a conventional matter including hot (“thermal”) or cold lamination.

According to step 314, the laminated layers are cut into a plurality of cards in a format suitable for transactional purposes. According to an embodiment, the cards are cut in a CR 80 format.

It will be appreciated that in the case where the substrate is provided in sheets, the sheets may be cut in a format of 22″×28″ or any format suitable for impressing the light filtering portion 212 (or parallax barrier portion 210). The cut sheets may then be cut again to suit a desired format such as the CR 80 format.

The embodiments of the invention described above are intended to be exemplary only. The scope of the invention is therefore intended to be limited solely by the scope of the appended claims.

We claim:

1. A hand-held decoder card for revealing information hidden in a printed material and information hidden in a color image, the hand-held decoder card comprising:
translucent material having a parallax barrier portion comprising parallel barrier lines for revealing the information hidden in the printed material; and
the translucent material having a light filtering portion comprising a light filter for revealing the information hidden in the color image.

2. The hand-held decoder card of claim 1, wherein the hand-held decoder card comprises a single layer of translucent material, thereby defining a monocoque card, and wherein the parallax barrier portion and the light filtering portion are on the single layer.

3. The hand-held decoder card of claim 1, wherein the translucent material comprises a barrier layer including the parallax barrier portion and a filter layer having the light filtering portion.

4. The hand-held decoder card of claim 1, wherein the translucent material further comprises an information bearing layer comprising an information bearing portion.

5. The hand-held decoder card of claim 4, wherein the information bearing portion comprises at least one of: a magnetic stripe, barcode, RFID, chip and PIN number.

6. The hand-held decoder card of claim 3, wherein the translucent material further comprises a liner layer on which are applied the barrier layer, the filter layer and the information bearing layer.

7. The hand-held decoder card of claim 1, wherein the light filtering portion comprises two parts of different colors thereby permitting viewing of two different images.

8. The hand-held decoder card of claim 1, wherein the parallax barriers have a specified distance between them, further wherein the parallax portion comprises two parts each having a different specified distance between the parallel barrier lines thereby permitting viewing of different information hidden in the printed material.

9. The hand-held decoder card of claim 1, wherein the card comprises a CR80 format.

10. The hand-held decoder card of claim 1, wherein the hand-held decoder card has a thickness comprised between 4 mil (0.004 inch) and 60 mil (0.06 inch).

11. A hand-held decoder card for revealing information hidden in a printed material and information hidden in a color image, the hand-held decoder card comprising:
translucent material having a transactional card format; and
the translucent material having a light filtering portion comprising a light filter for revealing the information hidden in the color image, the light filter having a specified color, the color being selected from one of the pantone colors.

12. The hand-held decoder card of claim 11, wherein the pantone colors comprise one of <<solid coated>> orange codes 150 to 173, including subcode 1505; red codes 178 to 222 and 485; red 032 C; rub. red C; warm red C; magenta codes 225 to 249; rhodamine red C; process magenta; purple codes 252 to 272, and 484 to 527; purple C, 1545-C; blue codes 2726 to 3035 (i.e., 272 to 303), 534 to 548, 7455 to 7459, 7462, 7463, 7473 to 7477; blue 072 C; process blue C; cyan codes 306 to 323, 7460 to 7463, 7466 to 7470; hexachrome cyan C; process cyan C; green codes 326 to 378, 554 to 576, 7480 to 7484, 803, 808; hexachrome green; and green C.

13. A hand-held decoder card for revealing information hidden in a printed material and information hidden in a color image, the hand-held decoder card comprising:
translucent material having a transactional card format; and
the translucent material having a parallax barrier portion comprising parallel barrier lines for revealing the information hidden in the printed material.

14. A method of using a plurality of cards of claim 13, wherein the parallax barriers of at least some cards have a different specified distance between them, the different cards hence revealing different information in the printed material and thereby providing a security measure.

15. A method for making a hand-held decoder card comprising a parallax barrier portion and a light filtering portion, the method comprising:
providing a translucent material;
impressing a parallax barrier portion comprising parallel barrier lines on a corresponding part of the translucent substrate material; and
impressing a light filtering portion comprising a light filter on another corresponding part of the translucent substrate material to provide the hand-held decoder card.

16. The method of claim 15, wherein the providing of a translucent material comprises providing a single layer of translucent material, thereby defining a monocoque card, and wherein the parallax barrier portion and the light filtering portion are impressed on the single layer.

17. The method of claim 15, wherein the providing of a translucent material comprises providing a barrier layer on which is impressed the parallax barrier portion and providing a filter layer on which is impressed the light filtering portion.

18. The method of claim 17, wherein the providing of a translucent material further comprises providing an information bearing layer, the method further comprising integrating a information bearing portion to the information bearing portion.

19. The method of claim 18, further comprising laminating all layers together.

20. The method of claim 19, further comprising die cutting the laminated layers into a plurality of cards in a CR 80 format.

21. The method of claim 15, wherein the providing of a filter layer comprises providing two parts of different colors thereby permitting viewing of two different images.

22. The method of claim 15, wherein the providing of a barrier layer comprises providing barriers having a specified distance between them, the specified distance being variable between different production runs of cards hence providing cards which can reveal different information in the printed material and thereby providing a security measure.

23. The method of claim 13, wherein the providing of a barrier layer comprises providing barriers having a specified distance between them, and further wherein the providing of a barrier layer comprises providing a different specified distance between the parallel barrier lines thereby permitting thereby permitting viewing of different information hidden in the printed material.

24. A method for making a hand-held decoder card comprising a parallax barrier portion and a light filtering portion, the method comprising:
providing a translucent material in transactional card format; and
impressing a parallax barrier portion comprising parallel barrier lines on a corresponding part of the translucent substrate material.

25. A method for making a hand-held decoder card comprising a parallax barrier portion and a light filtering portion, the method comprising:
providing a translucent material in transactional card format; and
impressing a light filtering portion comprising a light filter on another corresponding part of the translucent substrate material to provide the hand-held decoder card.
